(19) United States
(12) Patent Application Publication
(10) Pub. No.: US 2009/0067344 A1
(43) Pub. Date: Mar. 12, 2009

(54) System, apparatus, and method for assigning node addresses in a wireless network

(75) Inventors: Kerry S. Berland, Chicago, IL (US); James Ensinger, Buffalo Grove, IL (US)

Correspondence Address: LAW OFFICES OF EUGENE M. CUMMINGS, P.C., ONE NORTH WACKER DRIVE, SUITE 4130, CHICAGO, IL, 60606, US

(73) Assignee: Silicon Engines LTD

(21) Appl. No.: 11/900,734

(22) Filed: Sep. 12, 2007

(51) Int. Cl. H04L 12/28; G08B 13/14

(52) U.S. Cl. 370/254; 340/572.1

(57) ABSTRACT

A significant label is associated with at least one node of a wireless network through the use of a handheld wireless transceiver. A user passes the transceiver near a network node, causing the transceiver to read the unique address of the node. The user then enters a label holding significance into the transceiver, which associates the label with the unique address.

### FIELD OF THE INVENTION

The present invention relates generally to wireless networks and more particularly to improved systems, apparatus, and methods for assigning addresses to the nodes of a wireless network.

### DESCRIPTION OF THE PRIOR ART

Wireless networks are now ubiquitous, and, like many useful new technologies, new uses for wireless networking technology are constantly being developed. Numerous types of wireless networking are now in use, including base station and satellite based systems. Some wireless networking technologies are “Wi-Fi,” e.g., various wireless networking technologies based on IEEE standard 802.11, “Wi-Max,” which is based on IEEE 802.16, Global Systems for Mobile Communications (“GSM”), and many others.

One type of network technology that is used in both wired and wireless configurations is “mesh networking.” Mesh networks are networks whose nodes are capable of intelligently reconfiguring themselves to provide efficient data routes between arbitrary endpoints. In a mesh network, multiples nodes (usually every node) are capable of routing data, and therefore, a separate router is not required, as is common in more conventional networking technologies. Mesh technology has become especially important to wireless networks, as the routing adaptability inherent within meshes allows for the arbitrary expansion of the range of wireless networks without requiring powerful transmitters.

Most wireless mesh network technologies support an auto-addressing scheme, so that whenever a node is added, an address is automatically assigned. For instance, the ZigBee wireless mesh protocol initially assigns all addresses to a special node called a ZigBee Coordinator (ZC). As new nodes are added, the ZC allocates chunks of address space to the new nodes. Child nodes of the ZC can allocate blocks of their address space to new nodes as well. Other wireless mesh technologies use different addressing schemes, each with its own advantages and disadvantages.

In addition to traditional wireless networking purposes, e.g., providing Internet access to mobile computer users, wireless network solutions are being developed for automation systems, such as light systems, security systems, etc. When used in automation systems each node within the network is likely to perform a specific function. For instance, an intelligent switch could control the operation of a system of lights within a conference room. Frequently, administration personnel (installers, network maintenance personnel, etc.) will need to access particular nodes within such a network, such as when configuring parameters. Usually, accessing a particular node requires the address of that node, so that commands, embodied within packets, can reach the target node.

Often, installers will assign a label to each node that requires access.

A label is defined herein with a descriptive expression associated with, but not replacing, an underlying node address. Once a label is assigned to a particular node, a control application can query the device for its label and network address, and establish a database associating the node's label with its network address. Assuming the label is sufficiently descriptive, administration personnel can easily access the device in the future.

One way that labels are assigned is by connecting a laptop or other computing device to a node through a cable, and uploading the label. If there are a large number of nodes to configure, the process of assigning labels to nodes is inconvenient and time consuming.

The disclosed invention makes use of Radio Frequency Identification (“RFID”) technology. RFID technology is used to identify particular objects quickly. In a RFID system, a RFID tag is attached or embedded in a device, or even an animal or person. When the attached item needs to be identified, a RFID reader is brought close to the RFID tag. Radio waves from the RFID reader then activate the RFID tag, which broadcasts a stored identifier.

### OBJECTS OF THE INVENTION

Accordingly, it is an object of this invention to provide a system, apparatus, and method for assigning labels to nodes within a wireless network.

Another object of this invention is to provide a system, apparatus, and method for assigning labels to nodes within a wireless mesh network.

Yet another object of this invention is to provide a system, apparatus, and method for assigning labels to nodes within a wireless network without requiring the connection of a computer to the node via a USB cable or other means.

### SUMMARY OF THE INVENTION

The disclosed invention achieves its objectives through an innovative system for assigning comprehensible labels to nodes within wireless networks. A typical wireless network will include a plurality of nodes, with each of the nodes having a unique address. The unique address will usually be a four byte or larger quantity, which holds no special significance to users of the network—its sole purpose is to be absolutely unique. This invention introduces a wireless transceiver capable of reading the unique wireless network address from each node and associating a label that holds significance for users of the network with the unique address. In another aspect of the invention, each node will be coupled to a RFID tag, and the transceiver will read the unique address from the RFID tag. An additional improvement of the invention will allow the label to be written back into a memory array associated with each node, so that other network users can obtain and use the same labels that a first user has assigned.

### BRIEF DESCRIPTION OF THE DRAWINGS

Although the characteristic features of this invention will be particularly pointed out in the claims, the invention itself, and the manner in which it may be made and used, may be better understood by referring to the following description taken in connection with the accompanying drawings forming a part hereof, wherein like reference numerals refer to like parts throughout the several views and in which:

FIG. 1 depicts a handheld remote control for associating a user-chosen label to a wireless network node embodying one aspect of the disclosed invention;

FIG. 2 depicts a high-level schematic view showing one possible implementation of the remote control illustrated in FIG. 1;

FIG. 3 depicts a light fixture coupled to an RFID tag in accordance with one aspect of the disclosed invention;

FIG. 4 illustrates a factory setup procedure for a control unit constructed in accordance with one aspect of the disclosed invention;

FIG. 5 illustrates an installation procedure for a control unit constructed in accordance with one aspect of the disclosed invention;

### DETAILED DESCRIPTION OF THE ILLUSTRATED EMBODIMENT

The disclosed invention provides a simple method for installers to associate human readable labels with equipment using wireless networking. Opportunities for the use of wireless networking are enormous. For example, boardroom audio-visual systems frequently incorporate a hideaway projector. Usually, the projector's hideaway mechanism is wired to a controller. However, using wireless networking, a radio signal could be used to operate the projector.

Presently, wireless networking requires a good deal of technical understanding that is usually beyond the knowledge of an equipment installer. In particular, nodes in a wireless network are assigned long numerical addresses that cannot be remembered, understood, or effectively used by an installer. Numerous methods have been devised for handling this problem in normal networks, such as the use of short “IP” addresses, or network names. However, such schemes all require network specific technical knowledge.

The disclosed invention overcomes this problem by combining a wireless network node with RFID technology. A handheld remote control reads the network address of a wireless network node from a RFID tag coupled to the node. The installer then enters an understandable label into the remote control, which associates the node's network address and the label. An installer using the remote control will then be able to access the network node through the assigned label as opposed to the node's network address. Further, as an optional step, the label may be written to a memory array attached to the node so that it can be read back by other devices.

Using the disclosed invention a small device consisting of a RFID tag and some associated memory would be affixed to a piece of equipment before it was shipped. The unique address of the equipment would be read and stored in the memory associated with the RFID tag.

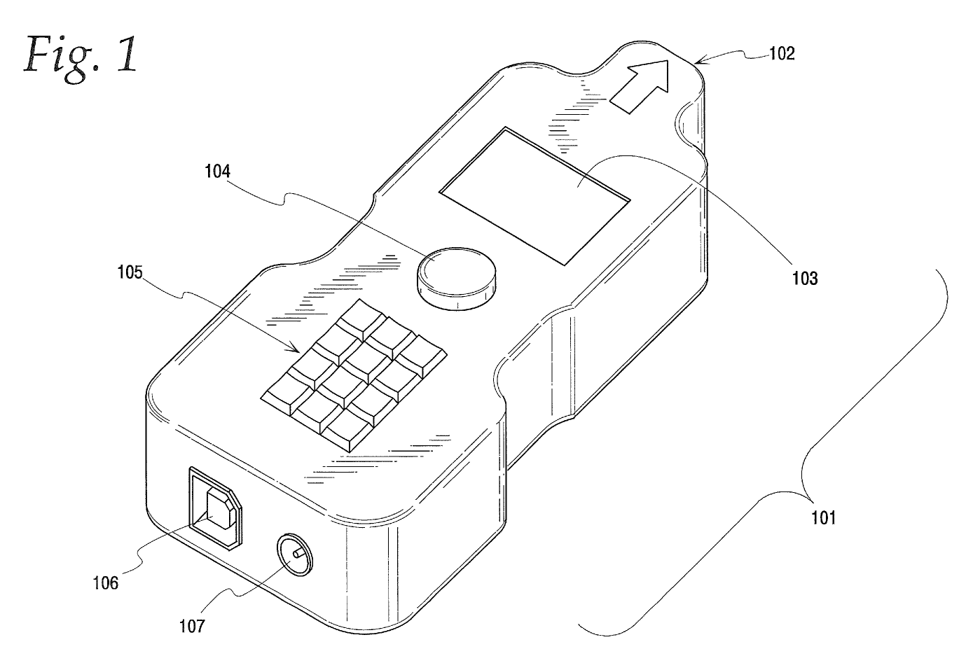

Turning to the figures, and to FIG. 1 in particular, a handheld remote control 101 is shown. The handheld remote 101 includes a display 103, which could be an organic light emitting display (OLED), liquid crystal display (LCD), or any other type of suitable display, such as a vacuum fluorescent display (VFD). A navigation button 104 is used to navigate options displayed on the display 103 and to select an option. In addition, keypad 105 has keys for entering alphanumeric values, such as convenient network labels, as well as additional keys for control functions. RFID scanner 102 allows the remote control 101 to receive network addresses stored in RFID tags, and to write information to RFID tags.

Remote control 101 also includes a USB port 106, which may be used to communicate with a computer to synchronize with enterprise control software or upgrade firmware within the remote control 101. Finally, a charger jack 107 allows batteries within remote control 101 to be recharged.

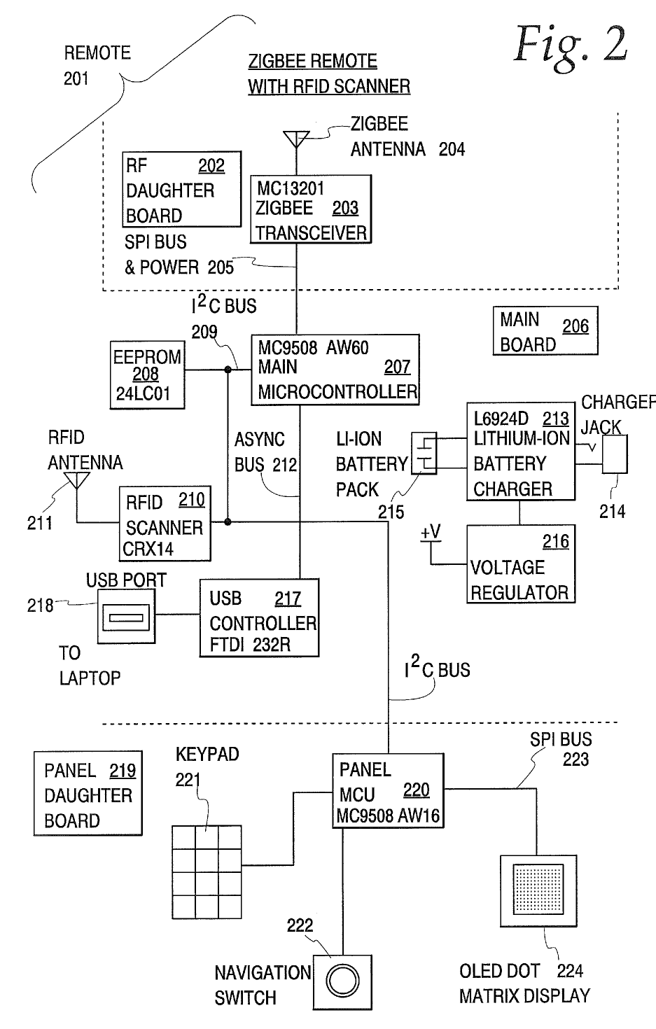

FIG. 2 depicts a high-level schematic view of handheld remote 101, consistent with the disclosed invention. An RF daughter board 202 houses wireless radio components, such as Zigbee RF components. Included on the RF daughter board is a wireless transceiver 203, such as a Zigbee transceiver, and an antenna 204. The antenna 204 could be implemented with a discrete antenna or as a foil pattern on the PC board crafted to resonate at the appropriate frequency. The daughter board 202 is coupled to the remainder of the system by connector 205, which includes a digital bus such as SPI bus, and a power connection.

The main board 206 includes a microcontroller 207, which may include some amount of non-volatile memory to house a wireless protocol stack and other firmware. An additional memory chip 208, which could be electrically eraseable programmable read-only memory (EEPROM), is connected to the microcontroller 207. The microcontroller 207 is also connected to RFID scanner chip 210 and panel board 219 via bus 209.

RFID scanner chip 210 is coupled to RFID antenna 222, which could be implemented as a foil pattern on main board 206. USB controller 217 is coupled to microcontroller 207 and to USB connector 218. A rechargeable battery 215 provides power for the remote control 101. The battery 215 is charged by a battery charger circuit 213, which receives power through charger jack 214.

Panel board 219 contains keypad 221, navigation switch 222 and display 224. The panel board 219 also contains a panel microcontroller 220, which contains firmware to interface with the keypad 221 and navigation switch 222, and control the display 224.

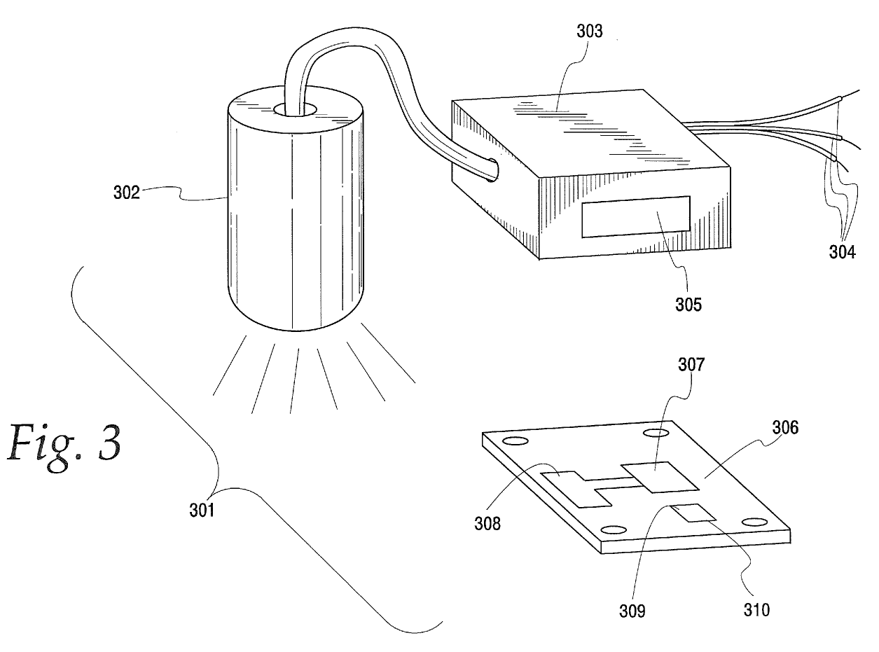

FIG. 3 shows an example light fixture 301 constructed in accordance with the disclosed invention. A control box 303 provides lamp power to lamp enclosure 302. A RFID tag 305 is affixed to the outside of control box 303. Control box 303 contains control board 306, which includes an RF chip 307 and RF antenna 308. Control board 306 also includes an EEPROM 309 for storing network address information 310.

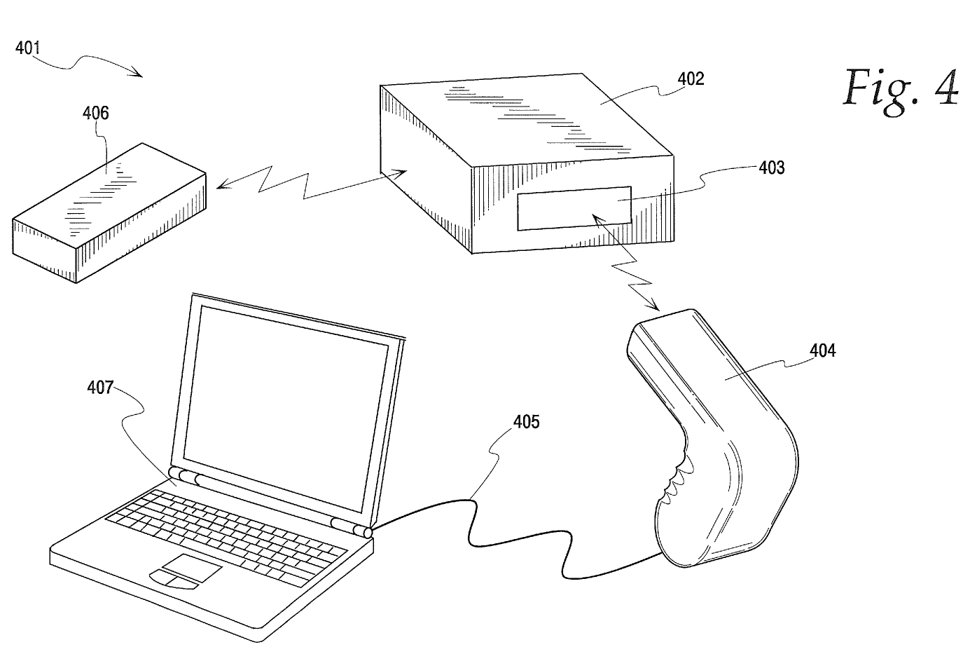

FIG. 4 illustrates the factory setup procedure for control box 402. A short-range wireless transceiver 406 wirelessly communicates with control box 402, while also communicating with test computer 407 via wired connection 405. Via the wireless transceiver 406, the test computer 407 learns the unique address of control box 402. A RFID scanner 404 then writes the unique address into the RFID tag 403 attached to the control box 402.

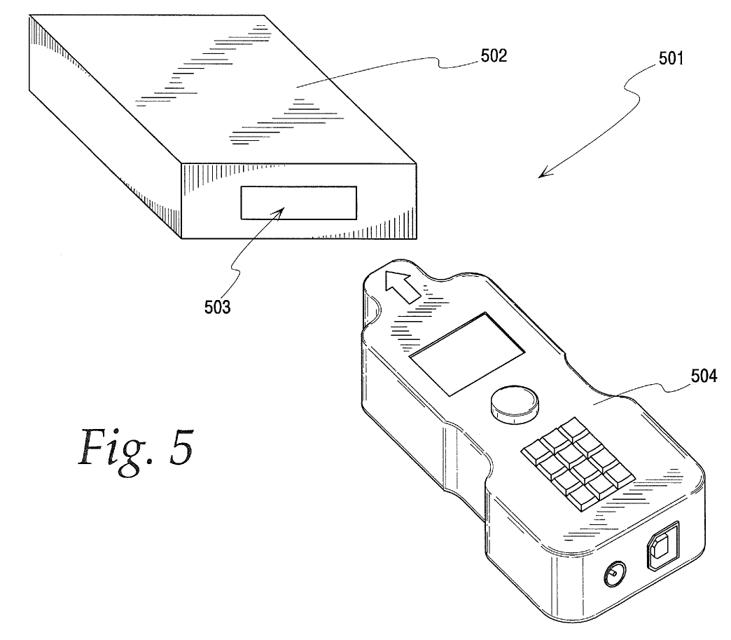

FIG. 5 illustrates a procedure that an installer could use to associate an understandable label with a piece of equipment using the disclosed invention. The installer would use remote 504 to read the unique address from RFID tag 503 on control box 502. The installer would then decide on a convenient address, and would enter that address using a keypad on remote 504. Memory within the remote 504 would then associate the unique address of the equipment with the convenient address chosen by the installer. Optionally, the convenient address would then be written into memory associated with RFID tag 503 as a safeguard against confusion between units.

The foregoing description of the invention has been presented for purposes of illustration and description, and is not intended to be exhaustive or to limit the invention to the precise form disclosed. The description was selected to best explain the principles of the invention and practical application of these principles to enable others skilled in the art to best utilize the invention in various embodiments and various modifications as are suited to the particular use contemplated. It is intended that the scope of the invention not be limited by the specification, but be defined by the claims set forth below.

We claim:

1. A system for assigning a label to a node within a wireless network comprising:
i) a wireless network comprising a plurality of nodes, wherein each of said nodes is assigned a unique wireless network address, and wherein each of said nodes includes a memory array storing said unique wireless network address;
ii) a wireless transceiver capable of reading said unique wireless network address from said memory arrays; and
iii) a processor coupled to said wireless transceiver for receiving said unique wireless address and associating said unique wireless network address with a label.

2. The system of claim 1, further comprising an input device coupled to said wireless transceiver, and wherein a user enters said label into said input device.

3. The system of claim 1, wherein each of said nodes further includes a RFID tag coupled to said memory array.

4. The system of claim 4, wherein said processor writes said label to said wireless transceiver which transmits said label to said RFID tag for storage within said memory array.

5. A method for assigning a label to a node within a wireless network comprising the steps of:
i) reading a wireless network address from said node;
ii) receiving a label into an apparatus wirelessly coupled to said node; and
iii) associating said wireless network address with said label.

6. The method of claim 5, further comprising the step of entering said label into an input device coupled to said apparatus.

7. The method of claim 5 further comprising the step of storing said label to a memory array coupled to said node.
